(19) United States
(12) Patent Application Publication
(10) Pub. No.: US 2014/0147280 A1
(43) Pub. Date: May 29, 2014

(54) SAFETY BRAKE

(71) Applicant: Ulrich Kowatsch, Leonberg (DE)

(72) Inventor: Ulrich Kowatsch, Leonberg (DE)

(21) Appl. No.: 14/232,439

(22) PCT Filed: Jun. 26, 2012
(86) PCT No.: PCT/EP2012/062289

§ 371 Date: Jan. 13, 2014

(30) Foreign Application Priority Data
Jul. 16, 2011 (DE) 10 2011 107 477.9

(51) Int. Cl. F03D 7/02; F16D 63/00; F16D 55/02

(52) U.S. Cl. CPC F03D 7/0244; F16D 55/02; F16D 63/00
USPC 416/169 R; 188/72.1; 188/72.3; 188/70 B

(57) ABSTRACT

The invention relates to a safety brake (12) for stopping a rotating device (38) in response to overheating. For this purpose, the safety brake (12) encompasses an expansion element (40), which, in the event of a heat-up, presses a first brake element (44) against a second brake element (48). After cool-down of the expansion element (40), the latter automatically releases the safety brake (12) again.

The invention relates to a safety brake for a device, in particular for wind turbines, which rotates with respect to a stationary bearing unit.

It is known to limit the rotational speed of rotating devices so as to avoid damages to the bearings or to the devices themselves. It is hereby often desirable to prevent rotation completely or to turn off the device, respectively.

To completely turn off a device, a locking mechanism is known from DE 10 2005 047 296 B3, which prevents a rotation of the device above a predetermined rotational speed. In the event that the locking mechanism is triggered, it must be disengaged again manually so as to release the device.

In contrast, the task of the invention is to provide a safety brake of the above-mentioned type, which stops automatically in response to a high load on the rotating device and which releases again automatically when the load decreases.

This task is solved according to the invention by means of a safety brake comprising the features of claim 1.

In response to a high load on the rotating device, the latter heats up and the expansion element brakes it with respect to the bearing unit to a standstill. A cool-down of the device takes place by means of this, whereby the expansion element contracts and the first brake element releases the second brake element again. A mechanical or manual activation of the safety brake for activating and for releasing the safety brake is not necessary. The operation of the device, which is provided with the brake, is facilitated considerably through this. For example, a wind turbine, which is difficult to access, does not need to be turned on again manually or with energy expenditure after a storm. The expansion element can thereby press the first brake element against the second brake element so strongly that the device is at a complete standstill. An expansion element, which is filled with wax, is preferably used as expansion element.

To be able to release the second brake element again quickly in response to a cool-down of the device, the first brake element can be capable of being moved against the force of a spring element. The spring element can thereby be embodied in the form of a helical spring or the like.

The second brake element preferably encompasses a brake disk or a brake ring. Brake disk and brake ring thereby represent standard parts, which can be replaced in a simple manner. The safety brake can be serviced easily through this.

The second brake element can be arranged or embodied at a shaft of the second device. A direct braking of the shaft is made possible through this.

Preferably, provision is made for a thermal bridge between the second brake element and the expansion element. The heat, which is generated at the second brake element in response to a braking, can be returned to the expansion element in this manner. An even braking is attained through this. A slip-stick effect is avoided.

Provision can be made in the area of the expansion element for a centrifugal brake between the rotating device and the bearing unit, wherein the safety brake is preferably provided as additional brake for the centrifugal brake.

Starting at a certain rotational speed, the centrifugal brake comes into action in this case, which leads to a heat-up. The expansion element expands due to the heat-up and brakes the second brake element via the first brake element. The safety brake thus protects the centrifugal brake from being overloaded or from overheating, respectively.

In a particularly preferred embodiment of the invention, the centrifugal brake encompasses at least one brake unit, which can be rotated about an axis of rotation, wherein the brake unit encompasses a brake shoe, which can be pressed against a brake drum and which is connected to a weight, which is movably provided outside of the brake drum. Due to the weight, which is provided outside of the brake drum, the centrifugal brake can build up a correspondingly high brake pressure, which is necessary to brake the bearing, even in response to low rotational speeds.

The weight is preferably connected to the brake shoe via traction mechanism. A rope, a chain, a rod or the like can be used as traction mechanism.

The traction mechanism can be connected to the brake shoe at one end and to the weight, which is movably guided in a weight guide, at the other end. The weight, which is connected to the brake shoe, can thus be guided safely.

The weight guide can be embodied in the form of a channel in a disk. Provision can be made on such a disk for a children's merry-go-round, for example. Such a weight guide can also be embodied in a rotor blade of a wind turbine. The rotor blade can thereby be embodied with a groove or a channel, for example, for guiding the weight. Due to the fact that one rotor blade is mandatory in the case of a wind turbine, a safety brake, which is embodied in this manner, can be produced in a highly cost-efficient manner.

Further features and advantages of the invention follow from the below detailed description of an exemplary embodiment of the invention, by means of the figures of the drawing, which show details, which are significant for the invention, as well as from the claims. The features shown therein should not necessarily be understood as being to scale and are illustrated such that the characteristics according to the invention can be made visible clearly. The different features can in each case be realized individually by themselves or in optional combinations in alternatives of the invention.

An exemplary embodiment of the invention is illustrated in the schematic drawing and is explained in more detail in the description below.

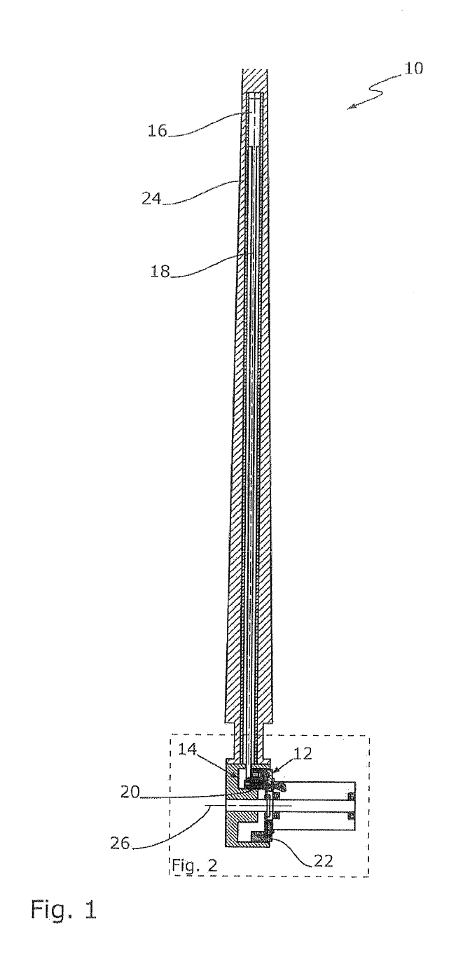

FIG. 1 shows a sectional partial view of a wind turbine comprising a safety brake according to the invention; and

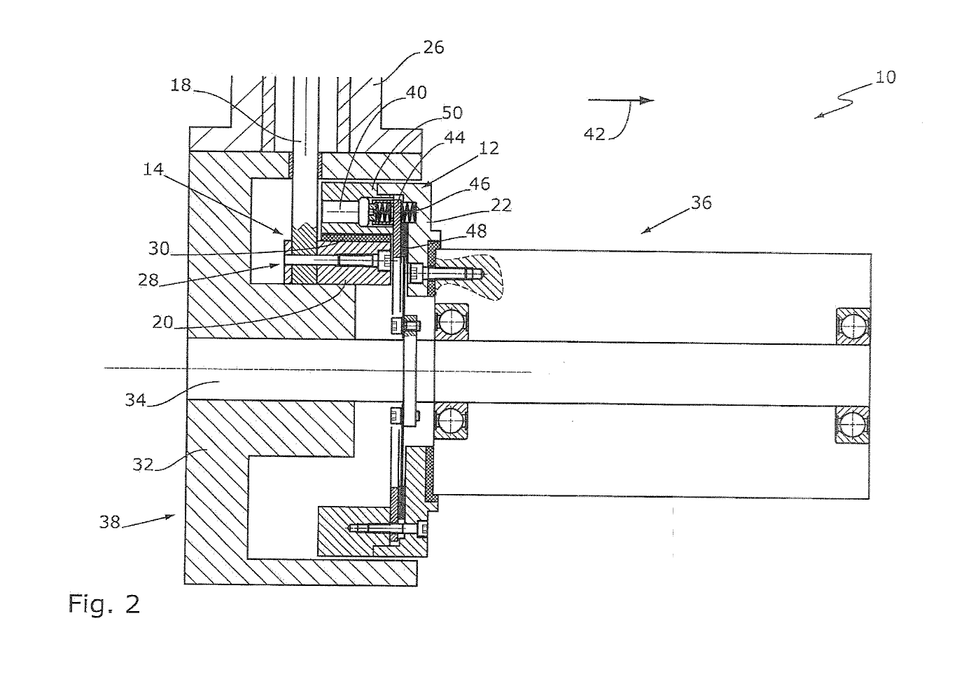

FIG. 2 shows an enlarged section of FIG. 1.

A portion of a wind turbine 10 comprising a safety brake 12 according to the invention is illustrated in FIG. 1. The safety brake 12 serves as additional brake for a centrifugal brake 14. The centrifugal brake 14 limits the rotational speed of the wind turbine 10, so that the latter is not damaged in a storm. To already reach a correspondingly high brake force in response to rotational speeds, which are comparatively low for centrifugal brakes, the centrifugal brake 14 encompasses at least one weight 16. The weight 16 is connected to a brake shoe 20 by means of a traction mechanism 18. In response to a correspondingly high rotational speed, the brake shoe 20 is pressed against the inner wall of a brake drum 22, whereby a braking is attained. The weight 16 is thereby movably guided in a weight guide 24. The weight guide 24 is embodied in a rotor blade of a wind turbine. Due to the large radial distance of the weight 16 to the brake shoe 20 or the axis of rotation 26 of the brake shoe 20, respectively, a high centrifugal force already acts on the weight 16 in response to low rotational speeds, so that the brake shoe 20 is pressed against the inner wall of the brake drum 22 with a sufficiently high pressure.

Details of the safety brake 12 and of the centrifugal force brake 14 can be found in the enlarged partial view according to FIG. 2. The traction mechanism 18 is thereby connected to the brake shoe 20 via a screw connection 28 and is embodied in the form of a rod. The brake shoe 20 encompasses friction surface 30 to increase the frictional forces between the brake shoe 20 and the brake drum 22.

The brake shoe 20, the traction mechanism 18 as well as the weight guide 24 are connected in a torque-proof manner to a hub 32 as well as to a shaft 34, which embody a rotating device 38. The device 38 is thereby embodied so as to be capable of rotating relative to a bearing unit 36.

In addition to the centrifugal brake 14, an additional brake in the form of the safety brake 12 is embodied between the bearing unit 36 and the second device 38. The safety brake 12 comprises an expansion element 40, which is filled with wax and which expands in longitudinal direction, that is, in the direction of an arrow 42, in response to heating up. In response to an expansion of the expansion element 40, a first brake element 44, which is arranged at the expansion element 40, is also displaced in the direction of the arrow 42. This displacement thereby takes place against the force of a spring element 46, which is arranged in the brake drum 22. By displacing the first brake element 44 in the direction of the arrow 42, a second brake element 48 is clamped between the first brake element 44 and the brake drum 22. The second brake element 48 is connected to the shaft 34 in a torque-proof manner, so that the relative movement between the bearing unit 36 and the device 38 comes to a standstill in response to an expanded expansion element 40. To increase the brake effect, the second brake element 48 is also provided on its outer side with a friction surface, which, for the sake of clarity, is not identified with a reference numeral. Due to the support of the safety brake 12, an overheating of the centrifugal brake 14 can thus be avoided.

The expansion element 40 is thereby arranged in the area of the centrifugal brake 14. The heat, which is created in response to the braking by means of the centrifugal brake 14, can thus be guided optimally to the expansion element 40.

Provision is made between the brake drum 22 and the expansion element 40 for a thermal bridge 50. The thermal bridge 50 thereby guides the heat, which is created in response to the braking of the second brake element 48, to the expansion element 40. A premature release of the safety brake 12 in response to the reduction of the brake effect is avoided through this by means of centrifugal brake 14.

As soon as the safety brake 12 has cooled down, the expansion element 40 contracts opposite the direction of the arrow 42 and releases the safety brake 12 by returning the first brake element 44 opposite the direction of the arrow 42. This movement is supported by relaxing the spring element 46. Due to the cool-down, the second brake element 48 can rotate freely again between the first brake element 44 and the brake drum 22.

In summary, the invention relates to a safety brake for stopping a heated rotating device. For this purpose, the safety brake encompasses an expansion element, which, in the event of a heat-up, presses a first brake element against a second brake element. After cool-down of the expansion element, the latter automatically releases the safety brake again.

1. A safety brake (12) for a device (38), in particular for wind turbines (10), which rotates with respect to a stationary bearing unit (36), characterized in that the bearing unit (36) encompasses an expansion element (40), at which a first brake element (44) is arranged or embodied, which can be pressed against a second brake element (48) of the device (38) by means of an expansion of the expansion element (40) in response to heat-up of the expansion element (40).

2. The safety brake according to claim 1, characterized in that the first brake element (44) can be moved against the force of a spring element (46).

3. The safety brake according to claim 1, characterized in that the second brake element (48) encompasses a brake disk or a brake ring.

4. The safety brake according to claim 1, characterized in that the second brake element (48) is arranged or embodied at a shaft (34) of the device (38).

5. The safety brake according to claim 1, characterized in that provision is made for a thermal bridge (50) between the second brake element (48) and the expansion element (40).

6. The safety brake according to claim 1, characterized in that provision is made in the area of the expansion element (40) for a centrifugal brake (14) between bearing unit (36) and device (38), wherein the safety brake (12) is provided as additional brake for the centrifugal brake (14).

7. The safety brake according to claim 6, characterized in that the centrifugal brake (14) encompasses at least one brake shoe (20), which can be rotated about an axis of rotation (26) and which can be pressed against a brake drum (22) and which. is connected to a weight (16), which is movably provided outside of the brake drum (22).

8. The safety brake according to claim 7, characterized in that the weight (16) is connected to the brake shoe (20) by means of a traction mechanism (18).

9. The safety brake according to claim 8, characterized in that the traction mechanism (18) is movably guided in a weight guide (24).

10. The safety brake according to claim 9, characterized in that the weight guide (24) is embodied in a rotor blade of a wind turbine.
